(19) United States
(12) Patent Application Publication
(10) Pub. No.: US 2021/0389780 A1
(43) Pub. Date: Dec. 16, 2021

(54) FACILITATION OF NON-AUTONOMOUS AND AUTONOMOUS VEHICLE INTERACTION FOR NEXT GENERATION NETWORKS

(71) Applicants: AT&T Intellectual Property I, L.P., Atlanta, GA (US); AT&T Mobility II LLC, Atlanta, GA (US)

(72) Inventors: Zhi Cui, Sugar Hill, GA (US); Sangar Dowlatkhah, Cedar Hill, TX (US); Nigel Bradley, Canton, GA (US); Ari Craine, Marietta, GA (US); Robert Koch, Peachtree Corners, GA (US)

(21) Appl. No.: 16/902,948

(22) Filed: Jun. 16, 2020

(51) Int. Cl. G05D 1/02; G05D 1/00; H04W 4/46; G08G 1/017; G08G 1/0967

(52) U.S. Cl. CPC G05D 1/0285; G05D 1/0027; G08G 1/096791; H04W 4/46; G08G 1/017; G05D 1/0295

(57) ABSTRACT

This disclosure describes a solution to facilitate interactions between non-autonomous and autonomous vehicles when sharing a road system. An edge network can provide resources to the vehicles such that non-autonomous and autonomous vehicles can operate in a harmonic and safe manner. Additionally, an augment reality display of the vehicles can be used to further facilitate communication between non-autonomous and autonomous vehicles. For example, a predicted direction or an imperative direction associated with an autonomous vehicle can be communicated to a non-autonomous vehicle such that an augmented reality display of the non-autonomous vehicle can alert the driver of the non-autonomous vehicle of a of such to increase safety measures.

### TECHNICAL FIELD

This disclosure relates generally to facilitating vehicle interaction. For example, this disclosure relates to facilitating non-autonomous and autonomous vehicle interaction for a 5G, or other next generation network, air interface.

### BACKGROUND

An autonomous vehicle (AV) is a vehicle that is capable of sensing its environment and moving safely with little or no human input. Self-driving cars combine a variety of sensors such as: radar, lidar, sonar, global positioning satellite (GPS), odometry and/or inertial measurement units. Advanced control systems interpret sensory information to identify appropriate navigation paths, as well as obstacles and relevant signage. Autonomous means self-governing. Many historical projects related to vehicle automation have been automated (made automatic) subject to a heavy reliance on artificial aids in their environment, such as magnetic strips. Autonomous control implies satisfactory performance under significant uncertainties in the environment and the ability to compensate for system failures without external intervention. One approach is to implement communication networks both in the immediate vicinity (for collision avoidance) and farther away (for congestion management). Such outside influences in the decision process reduce an individual vehicle's autonomy, while still not requiring human intervention. In this regard, automated vehicle implies a motor vehicle designed and constructed to move autonomously for certain periods of time without continuous driver supervision, but, in respect of which, driver intervention is still expected or required. A “fully automated vehicle” means a motor vehicle that has been designed and constructed to move autonomously without any driver supervision.

The above-described background relating to facilitating vehicle interaction is merely intended to provide a contextual overview of some current issues, and is not intended to be exhaustive. Other contextual information may become further apparent upon review of the following detailed description.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 illustrates an example wireless communication system in which network equipment (e.g., a network node device, or a network node) and user equipment (UE) can implement various aspects and embodiments of the subject disclosure.

FIG. 2 illustrates an example schematic system block diagram of an edge network according to one or more embodiments.

FIG. 3 illustrates an example schematic system block diagram of an edge network according to one or more embodiments.

FIG. 4 illustrates an example schematic system block diagram of an augmented reality view of a vehicle according to one or more embodiments.

FIG. 5 illustrates an example schematic system block diagram of an augmented reality view of a vehicle according to one or more embodiments.

FIG. 6 illustrates an example flow diagram for a method for facilitating autonomous and non-autonomous vehicle interaction network according to one or more embodiments.

FIG. 7 illustrates an example flow diagram for a system for facilitating autonomous and non-autonomous vehicle interaction network according to one or more embodiments.

FIG. 8 illustrates an example flow diagram for a machine-readable medium for facilitating autonomous and non-autonomous vehicle interaction network according to one or more embodiments.

FIG. 9 illustrates an example block diagram of an example mobile handset operable to engage in a system architecture that facilitates secure wireless communication according to one or more embodiments described herein.

FIG. 10 illustrates an example block diagram of an example computer operable to engage in a system architecture that facilitates secure wireless communication according to one or more embodiments described herein.

### DETAILED DESCRIPTION

In the following description, numerous specific details are set forth to provide a thorough understanding of various embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various machine-readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The words “exemplary” and/or “demonstrative” are used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

In addition, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, machine-readable device, computer-readable carrier, computer-readable media, or machine-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

As an overview, various embodiments are described herein to non-autonomous and autonomous vehicle interaction for a 5G air interface or other next generation networks. For simplicity of explanation, the methods are depicted and described as a series of acts. It is to be understood and appreciated that the various embodiments are not limited by the acts illustrated and/or by the order of acts. For example, acts can occur in various orders and/or concurrently, and with other acts not presented or described herein. Furthermore, not all illustrated acts may be desired to implement the methods. In addition, the methods could alternatively be represented as a series of interrelated states via a state diagram or events. Additionally, the methods described hereafter are capable of being stored on an article of manufacture (e.g., a machine-readable medium) to facilitate transporting and transferring such methodologies to computers. The term article of manufacture, as used herein, is intended to encompass a computer program accessible from any computer-readable device, carrier, or media, including a non-transitory machine-readable medium.

It should be noted that although various aspects and embodiments have been described herein in the context of 5G, Universal Mobile Telecommunications System (UMTS), and/or Long Term Evolution (LTE), or other next generation networks, the disclosed aspects are not limited to 5G, a UMTS implementation, and/or an LTE implementation as the techniques can also be applied in 3G, 4G or LTE systems. For example, aspects or features of the disclosed embodiments can be exploited in substantially any wireless communication technology. Such wireless communication technologies can include UMTS, Code Division Multiple Access (CDMA), Wi-Fi, Worldwide Interoperability for Microwave Access (WiMAX), General Packet Radio Service (GPRS), Enhanced GPRS, Third Generation Partnership Project (3GPP), LTE, Third Generation Partnership Project 2 (3GPP2) Ultra Mobile Broadband (UMB), High Speed Packet Access (HSPA), Evolved High Speed Packet Access (HSPA+), High-Speed Downlink Packet Access (HSDPA), High-Speed Uplink Packet Access (HSUPA), Zigbee, or another IEEE 802.12 technology. Additionally, substantially all aspects disclosed herein can be exploited in legacy telecommunication technologies.

Described herein are systems, methods, articles of manufacture, and other embodiments or implementations that can facilitate non-autonomous and autonomous vehicle interaction for a 5G network. Facilitating non-autonomous and autonomous vehicle interaction for a 5G network can be implemented in connection with any type of device with a connection to the communications network (e.g., a mobile handset, a computer, a handheld device, etc.) any Internet of things (TOT) device (e.g., toaster, coffee maker, blinds, music players, speakers, etc.), and/or any connected vehicles (cars, airplanes, space rockets, and/or other at least partially automated vehicles (e.g., drones), etc.). In some embodiments, the non-limiting term user equipment (UE) is used. It can refer to any type of wireless device that communicates with a radio network node in a cellular or mobile communication system. Examples of UE are target device, device to device (D2D) UE, machine type UE or UE capable of machine to machine (M2M) communication, PDA, Tablet, mobile terminals, smart phone, laptop embedded equipped (LEE), laptop mounted equipment (LME), USB dongles etc. The embodiments are applicable to single carrier as well as to multicarrier (MC) or carrier aggregation (CA) operation of the UE. The term carrier aggregation (CA) is also called (e.g. interchangeably called) “multi-carrier system”, “multi-cell operation”, “multi-carrier operation”, “multi-carrier” transmission and/or reception.

In some embodiments, the non-limiting term radio network node or simply network node is used. It can refer to any type of network node that serves UE is connected to other network nodes or network elements or any radio node from where UE receives a signal. Examples of radio network nodes are Node B, base station (BS), multi-standard radio (MSR) node such as MSR BS, eNode B, network controller, radio network controller (RNC), base station controller (BSC), relay, donor node controlling relay, base transceiver station (BTS), access point (AP), transmission points, transmission nodes, RRU, RRH, nodes in distributed antenna system (DAS) etc.

Cloud radio access networks (RAN) can enable the implementation of concepts such as software-defined network (SDN) and network function virtualization (NFV) in 5G networks. This disclosure can facilitate a generic channel state information framework design for a 5G network. Certain embodiments of this disclosure can include an SDN controller that can control routing of traffic within the network and between the network and traffic destinations. The SDN controller can be merged with the 5G network architecture to enable service deliveries via open application programming interfaces (“APIs”) and move the network core towards an all internet protocol (“IP”), cloud based, and software driven telecommunications network. The SDN controller can work with, or take the place of policy and charging rules function (“PCRF”) network elements so that policies such as quality of service and traffic management and routing can be synchronized and managed end to end.

5G, also called new radio (NR) access, networks can support the following: data rates of several tens of megabits per second supported for tens of thousands of users; 1 gigabit per second can be offered simultaneously to tens of workers on the same office floor; several hundreds of thousands of simultaneous connections can be supported for massive sensor deployments; spectral efficiency can be enhanced compared to 4G; improved coverage; enhanced signaling efficiency; and reduced latency compared to LTE. In multicarrier systems such as OFDM, each subcarrier can occupy bandwidth (e.g., subcarrier spacing). If the carriers use the same bandwidth spacing, then it can be considered a single numerology. However, if the carriers occupy different bandwidth and/or spacing, then it can be considered a multiple numerology.

Edge computing is a distributed computing paradigm which brings computation and data storage closer to the location where it is needed, to improve response times and save bandwidth. Edge networks can host applications and application components at the edge servers, resulting in commercial edge computing services that host applications such as dealer locators, shopping carts, real-time data aggregators, and ad insertion engines. Modern edge computing significantly extends this approach through virtualization technology that makes it easier to deploy and run a wide range of applications on the edge servers.

Devices at the edge constantly consume data coming from the cloud, forcing companies to build content delivery networks to decentralize data and service provisioning, leveraging physical proximity to the end user. In a similar way, the aim of edge computing is to move the computation away from data centers towards the edge of the network, exploiting smart objects, mobile phones, or network gateways to perform tasks and provide services on behalf of the cloud. By moving services to the edge, it is possible to provide content caching, service delivery, storage and IoT management resulting in better response times and transfer rates.

A user can be driving a non-autonomous vehicle A that can be networked via an access point 1 for the purpose of communicating with edge networks and/or a cloud network, such as via the internet. Edge nodes can be distributed and available along a path traversed by the vehicle. This disclosure describes an edge network-based solution, however, an alternative solution can employ a cloud-based architecture.

In one embodiment, the driver of the non-autonomous vehicle can be better informed about how nearby autonomous vehicles B and C and non-autonomous vehicle D are likely to interact with the non-autonomous vehicle A. Vehicles B, C, and D can also be in communication with the access point 1. Edge node 1 can maintain communication with each vehicle as long as the vehicle is in range of the access point 1. Additionally, some (e.g., various types of information as later discussed) or all information being disseminated to the various vehicles can be based on their respective distances to/from the access point device and/or each other. For instance, information sent from a passenger of a vehicle A may only be sent to Vehicle B if Vehicle A is within a certain distance of the access point 1, vehicle B is within a certain distance of access point 1, and/or if Vehicle A and Vehicle B are within a defined distance from each other. Therefore, edge node 1 can be knowledgeable of which vehicles are in range, are autonomous, are non-autonomous, and/or their respective distances from each other.

The edge nodes can collect data from all vehicles regarding the operation of the vehicle and can also communicate instructions to the autonomous vehicles to provide navigational and other commands.

The driver of vehicle A can be informed as to the operating mode of other nearby vehicles. For example, vehicle A can be can be equipped with an augmented reality (AR) view windshield. Alternatively, the driver of vehicle A can be equipped with augmented reality capabilities via eyeglasses or devices. The edge node 1 can send its knowledge of which other vehicles are autonomous and non-autonomous to vehicle A. The edge node 1 can also send current and/or predicted location information of each of the other vehicles so that vehicle A's AR system can correlate with the image that is viewed through the windshield to identify which vehicles correspond to which locations and present the AR displays accordingly. It should be noted that although discussed in reference to AR displays, embodiments within this disclosure can also be facilitated by any type of vehicle display screen.

Location information can be either reported by the vehicles to the edge node or the edge node can determine it if the edge node itself is controlling the navigation of the vehicle.

The vehicles can also communicate other publicly viewable information to the edge nodes and thereby make it available to the AR system of vehicle A. For instance, license plate numbers VIN numbers, and/or year/make/model of the vehicle can be displayed. Additionally, vehicles can be recognized by damage, modifications, and/or decorations (e.g., bumper stickers, flags, etc.). This information can be matched against a database such as an abduction alert system (e.g., AMBER alert) listing to identify vehicles being sought. Alternatively, if a vehicle is being sought in a specific area, the identifying information for the vehicle can be pushed to the edge nodes within that area for faster processing. Consequently, an alert system AR overlay can be displayed as a result.

Passengers in vehicles B, C, and D can also display data that they wish to have presented to the AR displays of vehicle A. This data can be sent from vehicle A to the edge nodes. This data can be sent to the edge nodes via a passenger's mobile device, wherein the data can include text, image, audio, video, and/or other media. The passenger's device can be associated with the vehicle they are riding in and the vehicle can send the data on behalf of the passenger. The association can occur based on GPS, near-field communication (e.g., the passenger's mobile device is communicating with vehicle A via Bluetooth, Wi-Fi, or some other radio communication). The public display data can therefore be sent to vehicle A and displayed via an AR system of vehicle A.

Alternatively, if vehicle B is autonomous, its upcoming actions can be already known based on a planned route and real-time nearby conditions. These upcoming actions can be communicated to vehicle B from an edge node that is controlling vehicle B, or vehicle B can communicate its planned actions to the edge node. In either case, the edge node can use this data to alert the driver of vehicle A of vehicle B's upcoming actions via vehicle A's AR display. For instance, an upcoming turn for vehicle B can be displayed on vehicle A's AR system. In a similar manner, an approaching ambulance can be identified via the AR display of vehicle A. The edge node can detect the ambulance within range and alert vehicles in range and calculate the best path for each vehicle to take to allow the ambulance to pass. Consequently, the expected paths of other vehicles that are expected to reroute based on the ambulance can be displayed via AR to each vehicle in the scenario.

In the event that the driver of vehicle A does not react as instructed within a defined time period, the edge node can send instructions to vehicle A to instruct vehicle A what to do, in effect converting vehicle A from non-autonomous to autonomous mode temporarily. This scenario can be facilitated by vehicles that have autonomous capabilities that may or may not be being used currently. In effect, the system can override a vehicle that is being operated in non-autonomous mode if the driver of the vehicle has not complied with an emergency directive.

Likewise, if the edge node detects that an oncoming vehicle is on a path for a collision, the edge node can calculate the best paths for nearby autonomous and non-autonomous vehicles to take to avoid a collision. These instructions can be sent to each affected vehicle. In the case of non-autonomous vehicle A, the edge node can immediately invoke an auto pilot mode and send instructions to vehicle A to switch it to autonomous mode and control it according to the evasive instructions.

Additionally, objects other than vehicles can be detected and their motion can be brought to the attention of the driver of Vehicle A. Other sensors in the vicinity that are also networked to a proximate edge node can detect conditions of an object that can affect the driver. These sensors can be motion detectors, video cameras, microphones, etc. For instance, a video camera can detect motion of an object in an area that is hidden from the view of the driver of vehicle A (e.g., a deer about to run from behind a bush and into the street). This object can be a person, wildlife, and/or other potentially dangerous objects, such as blowing debris. The video camera can also detect the object's motion over time to predict a future motion path. If the predicted future motion path is determined to meet a likelihood threshold, an AR alert can be presented to the driver.

It should also be noted that an artificial intelligence (AI) component can facilitate automating one or more features in accordance with the disclosed aspects. A memory and a processor as well as other components can include functionality with regard to the figures. The disclosed aspects in connection with facilitating communications between autonomous and non-autonomous can employ various AI-based schemes for carrying out various aspects thereof. For example, a process for detecting one or more trigger events, facilitating an AR view as a result of the one or more trigger events, and/or modifying one or more reported measurements, and so forth, can be facilitated with an example automatic classifier system and process. In another example, a process for penalizing one AR view while preferring another AR view can be facilitated with the example automatic classifier system and process.

An example classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that can be automatically performed.

A support vector machine (SVM) is an example of a classifier that can be employed. The SVM can operate by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, for example, naïve Bayes, Bayesian networks, decision trees, neural networks, fuzzy logic models, and probabilistic classification models providing different patterns of independence can be employed. Classification as used herein also may be inclusive of statistical regression that is utilized to develop models of priority.

The disclosed aspects can employ classifiers that are explicitly trained (e.g., via a generic training data) as well as implicitly trained (e.g., via observing mobile device usage as it relates to triggering events, observing network frequency/technology, receiving extrinsic information, and so on). For example, SVMs can be configured via a learning or training phase within a classifier constructor and feature selection module. Thus, the classifier(s) can be used to automatically learn and perform a number of functions, including but not limited to modifying AR views, modifying one or more reported vehicle measurements, and so forth. The criteria can include, but is not limited to, predefined values, frequency attenuation tables or other parameters, service provider preferences and/or policies, and so on.

In one embodiment, described herein is a method comprising receiving, by an access point device comprising a processor, first location data representative of a first location of a first vehicle. The method can comprise receiving, by the access point device, second location data representative of a second location of a second vehicle and a predicted location of the second vehicle. Additionally, the method can comprise receiving, by the access point device from a user equipment, display data, representative of a display to be associated with the second vehicle, wherein the user equipment is located within the second vehicle. Furthermore, in response to receiving the second location data and based on a first distance between the access point and the first vehicle being determined to be less than a first threshold distance, and a second distance between the access point device and the second vehicle being determined less than a second threshold distance, the method can comprise sending, by the access point device, the second location data and the display data to the first vehicle to facilitate an augmented reality display of the second vehicle and the display data via a display screen of the first vehicle. Furthermore, based on the sending the second location data and the display data, the method can comprise facilitating, by the access point device, a maneuver of the first vehicle to avoid the predicted location.

According to another embodiment, a system can facilitate receiving first vehicle data representative of a first vehicle. The system can comprise receiving second vehicle data, representative of a second vehicle, wherein the second vehicle data comprises a current location of the second vehicle and a predicted location of the second vehicle. Additionally, the system can comprise receiving display data, representative of a display to be associated with the second vehicle, from a user equipment located within the second vehicle. Furthermore, in response to a first condition being determined to be present with respect to a first distance between the first vehicle and the network equipment, and a second condition being determined to be present with respect to a second distance between the second vehicle and the network equipment, wherein the first condition and the second condition is a same condition, the system can comprise sending the second vehicle data and the display data to the first vehicle to facilitate an augmented reality display of the second vehicle and the display data via a display screen of the first vehicle.

According to yet another embodiment, described herein is a machine-readable medium that can perform the operations comprising receiving first vehicle information representative of a non-autonomous vehicle. The machine-readable medium can perform the operations comprising receiving autonomous vehicle information, representative of an autonomous vehicle, wherein the autonomous vehicle information comprises a current location of the autonomous vehicle and a predicted location of the autonomous vehicle. The machine-readable medium can perform the operations comprising receiving text data, representative of a text to be associated with the autonomous vehicle, from a user equipment located within the autonomous vehicle. Additionally, in response to at least two distances among the non-autonomous vehicle, the autonomous vehicle, or an access point device being determined to be less than a threshold distance, the machine-readable medium can comprise sending the autonomous vehicle information to the non-autonomous vehicle to facilitate, via a display screen of the non-autonomous vehicle, an augmented reality display of the autonomous vehicle and the text. Additionally, in response to the sending, the machine-readable medium can comprise facilitating a temporary override of the non-autonomous vehicle to prevent the non-autonomous vehicle from reaching the predicted location.

These and other embodiments or implementations are described in more detail below with reference to the drawings.

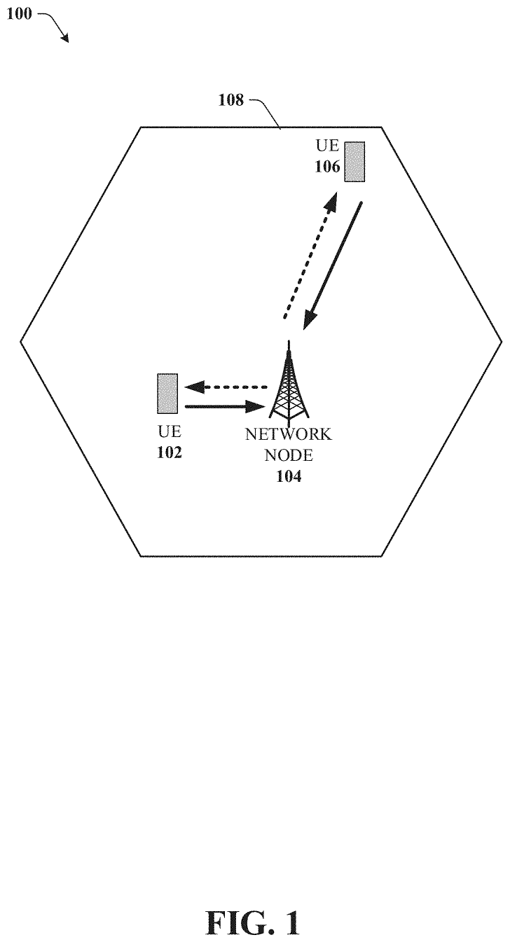

Referring now to FIG. 1, illustrated is an example wireless communication system 100 in accordance with various aspects and embodiments of the subject disclosure. In one or more embodiments, system 100 can include one or more user equipment UEs 102. The non-limiting term user equipment can refer to any type of device that can communicate with a network node in a cellular or mobile communication system. A UE can have one or more antenna panels having vertical and horizontal elements. Examples of a UE include a target device, device to device (D2D) UE, machine type UE or UE capable of machine to machine (M2M) communications, personal digital assistant (PDA), tablet, mobile terminals, smart phone, laptop mounted equipment (LME), universal serial bus (USB) dongles enabled for mobile communications, a computer having mobile capabilities, a mobile device such as cellular phone, a laptop having laptop embedded equipment (LEE, such as a mobile broadband adapter), a tablet computer having a mobile broadband adapter, a wearable device, a virtual reality (VR) device, a heads-up display (HUD) device, a smart car, a machine-type communication (MTC) device, and the like. User equipment UE 102 can also include IOT devices that communicate wirelessly.

In various embodiments, system 100 is or includes a wireless communication network serviced by one or more wireless communication network providers. In example embodiments, a UE 102 can be communicatively coupled to the wireless communication network via a network node 104. The network node (e.g., network node device) can communicate with user equipment (UE), thus providing connectivity between the UE and the wider cellular network. The UE 102 can send transmission type recommendation data to the network node 104. The transmission type recommendation data can include a recommendation to transmit data via a closed loop MIMO mode and/or a rank-1 precoder mode.

A network node can have a cabinet and other protected enclosures, an antenna mast, and multiple antennas for performing various transmission operations (e.g., MIMO operations). Network nodes can serve several cells, also called sectors, depending on the configuration and type of antenna. In example embodiments, the UE 102 can send and/or receive communication data via a wireless link to the network node 104. The dashed arrow lines from the network node 104 to the UE 102 represent downlink (DL) communications and the solid arrow lines from the UE 102 to the network nodes 104 represents an uplink (UL) communication.

System 100 can further include one or more communication service provider networks 106 that facilitate providing wireless communication services to various UEs, including UE 102, via the network node 104 and/or various additional network devices (not shown) included in the one or more communication service provider networks 106. The one or more communication service provider networks 106 can include various types of disparate networks, including but not limited to: cellular networks, femto networks, picocell networks, microcell networks, internet protocol (IP) networks Wi-Fi service networks, broadband service network, enterprise networks, cloud-based networks, and the like. For example, in at least one implementation, system 100 can be or include a large-scale wireless communication network that spans various geographic areas. According to this implementation, the one or more communication service provider networks 106 can be or include the wireless communication network and/or various additional devices and components of the wireless communication network (e.g., additional network devices and cell, additional UEs, network server devices, etc.). The network node 104 can be connected to the one or more communication service provider networks 106 via one or more backhaul links 108. For example, the one or more backhaul links 108 can include wired link components, such as a T1/E1 phone line, a digital subscriber line (DSL) (e.g., either synchronous or asynchronous), an asymmetric DSL (ADSL), an optical fiber backbone, a coaxial cable, and the like. The one or more backhaul links 108 can also include wireless link components, such as but not limited to, line-of-sight (LOS) or non-LOS links which can include terrestrial air-interfaces or deep space links (e.g., satellite communication links for navigation).

Wireless communication system 100 can employ various cellular systems, technologies, and modulation modes to facilitate wireless radio communications between devices (e.g., the UE 102 and the network node 104). While example embodiments might be described for 5G new radio (NR) systems, the embodiments can be applicable to any radio access technology (RAT) or multi-RAT system where the UE operates using multiple carriers e.g. LTE FDD/TDD, GSM/GERAN, CDMA2000 etc.

For example, system 100 can operate in accordance with global system for mobile communications (GSM), universal mobile telecommunications service (UMTS), long term evolution (LTE), LTE frequency division duplexing (LTE FDD, LTE time division duplexing (TDD), high speed packet access (HSPA), code division multiple access (CDMA), wideband CDMA (WCMDA), CDMA2000, time division multiple access (TDMA), frequency division multiple access (FDMA), multi-carrier code division multiple access (MC-CDMA), single-carrier code division multiple access (SC-CDMA), single-carrier FDMA (SC-FDMA), orthogonal frequency division multiplexing (OFDM), discrete Fourier transform spread OFDM (DFT-spread OFDM) single carrier FDMA (SC-FDMA), Filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM CP-OFDM, resource-block-filtered OFDM, Wi Fi, WLAN, WiMax, and the like. However, various features and functionalities of system 100 are particularly described wherein the devices (e.g., the UEs 102 and the network device 104) of system 100 are configured to communicate wireless signals using one or more multi carrier modulation schemes, wherein data symbols can be transmitted simultaneously over multiple frequency subcarriers (e.g., OFDM, CP-OFDM, DFT-spread OFMD, UFMC, FMBC, etc.). The embodiments are applicable to single carrier as well as to multicarrier (MC) or carrier aggregation (CA) operation of the UE. The term carrier aggregation (CA) is also called (e.g. interchangeably called) “multi-carrier system”, “multi-cell operation”, “multi-carrier operation”, “multi-carrier” transmission and/or reception. Note that some embodiments are also applicable for Multi RAB (radio bearers) on some carriers (that is data plus speech is simultaneously scheduled).

In various embodiments, system 100 can be configured to provide and employ 5G wireless networking features and functionalities. 5G wireless communication networks are expected to fulfill the demand of exponentially increasing data traffic and to allow people and machines to enjoy gigabit data rates with virtually zero latency. Compared to 4G, 5G supports more diverse traffic scenarios. For example, in addition to the various types of data communication between conventional UEs (e.g., phones, smartphones, tablets, PCs, televisions, Internet enabled televisions, etc.) supported by 4G networks, 5G networks can be employed to support data communication between smart cars in association with driverless car environments, as well as machine type communications (MTCs). Considering the drastic different communication demands of these different traffic scenarios, the ability to dynamically configure waveform parameters based on traffic scenarios while retaining the benefits of multi carrier modulation schemes (e.g., OFDM and related schemes) can provide a significant contribution to the high speed/capacity and low latency demands of 5G networks. With waveforms that split the bandwidth into several sub-bands, different types of services can be accommodated in different sub-bands with the most suitable waveform and numerology, leading to an improved spectrum utilization for 5G networks.

To meet the demand for data centric applications, features of proposed 5G networks may include: increased peak bit rate (e.g., 20 Gbps), larger data volume per unit area (e.g., high system spectral efficiency—for example about 3.5 times that of spectral efficiency of long term evolution (LTE) systems), high capacity that allows more device connectivity both concurrently and instantaneously, lower battery/power consumption (which reduces energy and consumption costs), better connectivity regardless of the geographic region in which a user is located, a larger numbers of devices, lower infrastructural development costs, and higher reliability of the communications. Thus, 5G networks may allow for: data rates of several tens of megabits per second should be supported for tens of thousands of users, 1 gigabit per second to be offered simultaneously to tens of workers on the same office floor, for example; several hundreds of thousands of simultaneous connections to be supported for massive sensor deployments; improved coverage, enhanced signaling efficiency; reduced latency compared to LTE.

The upcoming 5G access network may utilize higher frequencies (e.g., >6 GHz) to aid in increasing capacity. Currently, much of the millimeter wave (mmWave) spectrum, the band of spectrum between 30 gigahertz (GHz) and 300 GHz is underutilized. The millimeter waves have shorter wavelengths that range from 10 millimeters to 1 millimeter, and these mmWave signals experience severe path loss, penetration loss, and fading. However, the shorter wavelength at mmWave frequencies also allows more antennas to be packed in the same physical dimension, which allows for large-scale spatial multiplexing and highly directional beamforming.

Performance can be improved if both the transmitter and the receiver are equipped with multiple antennas. Multi-antenna techniques can significantly increase the data rates and reliability of a wireless communication system. The use of multiple input multiple output (MIMO) techniques, which was introduced in the third-generation partnership project (3GPP) and has been in use (including with LTE), is a multi-antenna technique that can improve the spectral efficiency of transmissions, thereby significantly boosting the overall data carrying capacity of wireless systems. The use of multiple-input multiple-output (MIMO) techniques can improve mmWave communications, and has been widely recognized a potentially important component for access networks operating in higher frequencies. MIMO can be used for achieving diversity gain, spatial multiplexing gain and beamforming gain. For these reasons, MIMO systems are an important part of the 3rd and 4th generation wireless systems, and are planned for use in 5G systems.

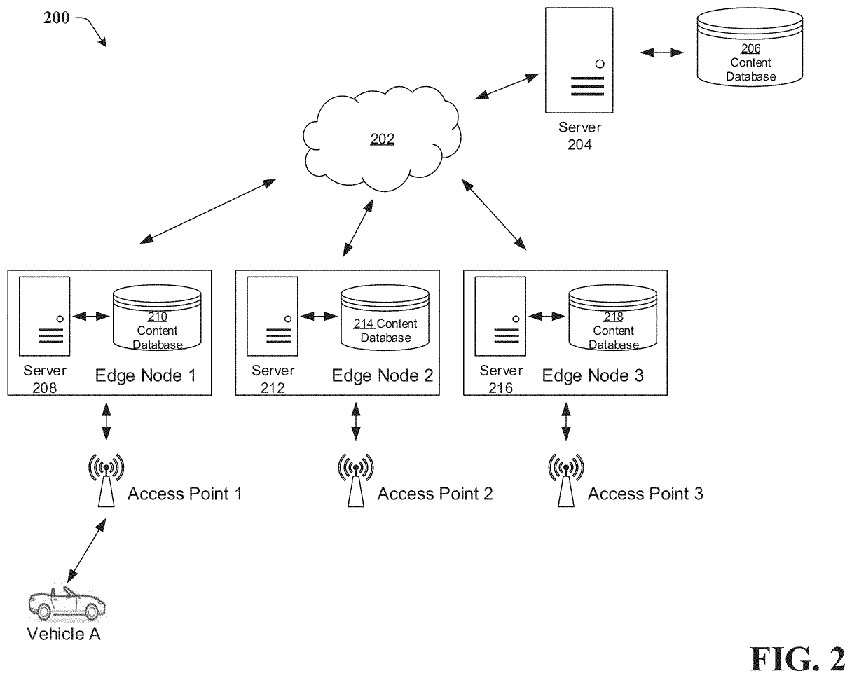

Referring now to FIG. 2, illustrated is an example schematic system block diagram of an edge network 200 according to one or more embodiments. The edge network 200 can comprise a cloud-based architecture 202 via a cloud server 204 and a content database 206. The cloud-based architecture 202 can be in communication with one or more edge nodes (e.g., edge node 1, edge node 2, edge node 3, etc.). It should be noted that although FIG. 2 depicts three edge nodes, any number of edge nodes are possible to facilitate the spirit of this disclosure. The edge nodes can move vehicle services to the edge, where they can provide content caching, service delivery, storage, and IoT management resulting in better response times and transfer rates ideal for autonomous and non-autonomous vehicles. Each edge node 1, 2, 3 can comprise its own server and content database to store relevant content. For example, edge node 1 can comprise server 208 and content database 210, edge node 2 can comprise server 212 and content database 214, and edge node 3 can comprise serer 216 and content database 218. Access points 1, 2, 3 can be utilized to facilitate communication from vehicles to edge nodes 1, 2, 3, respectively. For example, vehicle A can communicate with the edge node 1 via the access point 1, such that wireless services are readily available for vehicle A. These wireless services can also be hosted at and/or communicated over the cloud-based architecture 202 to the server 204 and content database 206. The edge nodes 1, 2, 3 can be distributed in such a manner that when the vehicle A is out of range (or nearing the range threshold) of the access point 1, the access point 2 can begin communicating with the vehicle A such that there is no disruption in any of the services that were being provided to the vehicle A by the access point 2.

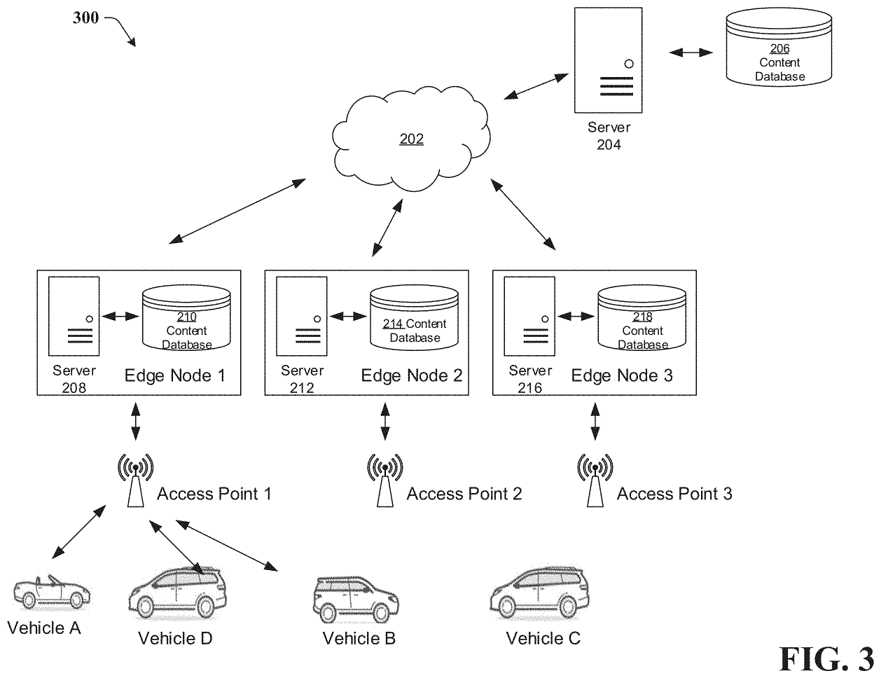

Referring now to FIG. 3, illustrated is an example schematic system block diagram of an edge network 300 according to one or more embodiments.

In one embodiment, the driver of a non-autonomous vehicle (e.g., vehicle A) may need to be better informed about how nearby autonomous vehicles B and C and non-autonomous vehicle D are likely to interact with vehicle A. Vehicles B, C, and/or D can also be in communication with access point 1. The content database of 210 of edge node 1 can maintain data regarding whether vehicles B, C, D are autonomous or non-autonomous if they are within range of the edge node 1. This data can be received via the access node 1 and then sent from the access node 1 to the vehicle A. Edge node 1 can maintain communication with each vehicle as long as the vehicles are in range of the access point 1. Consequently, the edge node 1 can maintain data that is representative of the disposition of each vehicle in range and whether each vehicle is autonomous or non-autonomous. The edge node 1 can collect data from all of the vehicles regarding the operation of the vehicle and may also communicate instructions to the autonomous vehicles to provide navigational and other commands. The driver of vehicle A can also be informed as to the operating mode of other nearby vehicles. For example, the access point 1 can communicate to the vehicle A that vehicles B and C are autonomous, whereas vehicle D has a driver while these vehicles are in range of the access point 1.

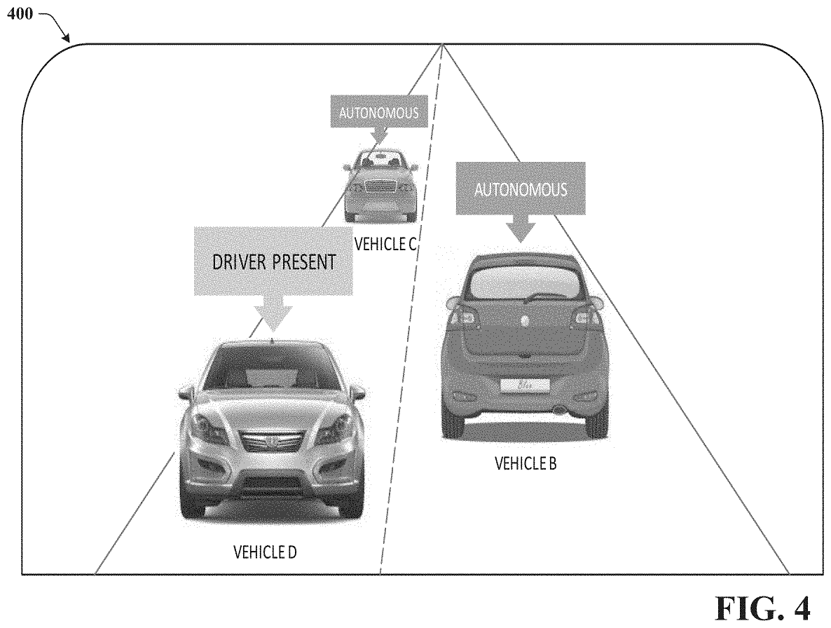

Referring now to FIG. 4, illustrated is an example schematic system block diagram of an augmented reality display 400 of a vehicle according to one or more embodiments.

Vehicle A can also include the augmented reality display 400 (e.g., on its windshield) that can facilitate displaying various characteristics associated with each vehicle. Edge node 1 can send current and/or predicted location information of each of the other vehicles, to vehicle A, so that driver of vehicle A can view the image on the windshield to identify which vehicles correspond to which locations. The location information of each vehicle can be reported to the edge node 1 by the vehicle, or the edge node 1, itself, can control the navigation of the vehicle and thus already be aware of the vehicle's location and/or predicted location. Alternatively, other information can be sent from the edge node 1 to the vehicle A. For example, the year, make, and model of the vehicles B, C, D can be sent to the vehicle A for augmented reality display. Additionally, passenger information can be sent to the edge node 1 via the access point 1 for display by the vehicle A. For example, if a passenger is riding in vehicle C and would like to communicate some type of information to be displayed publicly, then the passenger of vehicle C can send this information (e.g., text, picture, video) to the vehicle A (and/or other vehicles) via a connection between the passenger's mobile device and vehicle C, which will then be sent to the access point 1, or from the mobile device directly to the access point 1. It should be noted that if the information is sent directly to the access point 1, then other mechanisms such as GPS, location based services, and/or near field communication can associate the passenger with the vehicle C such that other vehicles will know where the information is coming from.

It should also be noted that, in some embodiments, some or all of the aforementioned data that can be communicate to the vehicle A directly through the access point 1 can also be communicated through another access point. For example, if vehicle C is communicating with access point 3, then data from vehicle C can be sent up to the cloud-based architecture through edge node 3. In turn, the cloud-based architecture can send that information down through edge node 1 and access point 1 to be communicated to the vehicle A.

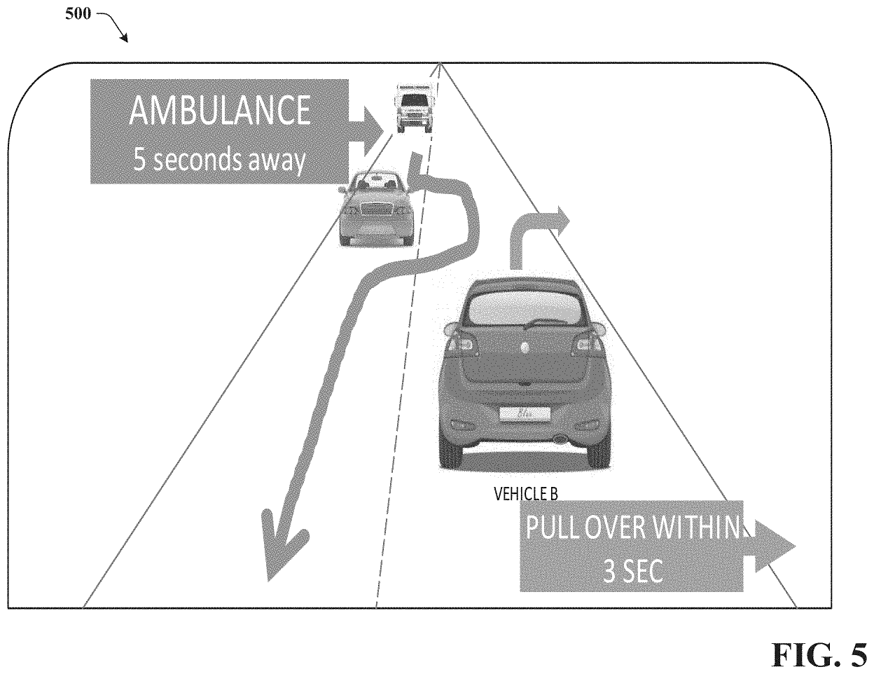

Referring now to FIG. 5 illustrates an example schematic system block diagram of an augmented reality display 500 of a vehicle according to one or more embodiments.

The edge network 200 can also facilitate the transmission of other information to the AR display 500. For example, the routes of oncoming emergency vehicles can be sent to the vehicle A for AR display. Based on the route of the emergency vehicle, the AR display 500 can communicate a route that the driver of the vehicle A should take to prevent impending the emergency vehicle. In addition to the route, a time parameter can be displayed alerting the driver of vehicle A that he/she should alter his/her route within a defined period of time to prevent impeding the emergency vehicle (e.g., pull over within 3 seconds). In some scenarios, if the vehicle A is not fully non-autonomous but does have some autonomous capabilities (e.g., auto-pilot), the edge node 1 can transmit a directive to the vehicle A to engage its autonomous features to pull the vehicle A of the road should the driver of the vehicle A not react in enough time to prevent impendence of the emergency vehicle. It should be noted that the use of the emergency vehicle is only but one use case and that this scenario can apply to other non-emergency vehicles as well. In addition to the aforementioned information being display via the AR display 500, the AR display 500 can also display data associated with nearby vehicles that are also being directed in response to the oncoming emergency vehicle. For example, if the vehicle B, in front of the vehicle A, is set to stop in 5 seconds, then the AR display (of vehicle A) can display that information and where the threshold for vehicle B stopping should begin and end. This essentially provides the driver of vehicle A with a heads-up that although he/she is receiving a directive, nearby vehicles are also receiving a directive, and those directives should be taken into account by the driver of vehicle A to increase safety measures during the situation.

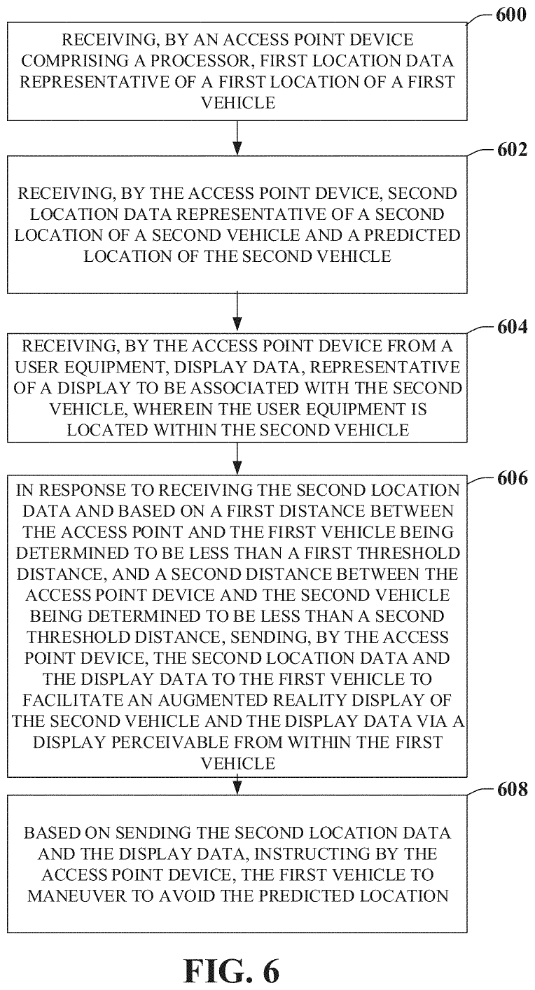

Referring now to FIG. 6, illustrated is an example flow diagram for a method for facilitating autonomous and non-autonomous vehicle interaction network according to one or more embodiments.

At element 600, the method can comprise receiving, by an access point device comprising a processor, first location data representative of a first location of a first vehicle. At element 602, the method can comprise receiving, by the access point device, second location data, representative of a second location of a second vehicle, wherein the second location data comprises a current location of the second vehicle and a predicted location of the second vehicle. Additionally, at element 604, the method can comprise receiving, by the access point device from a user equipment, display data, representative of a display to be associated with the second vehicle, wherein the user equipment is located within the second vehicle. Furthermore, in response to receiving the second location data and based on a first distance between the access point and the first vehicle being determined to be less than a first threshold distance, and a second distance between the access point device and the second vehicle being determined less than a second threshold distance, at element 606, the method can comprise sending, by the access point device, the second location data and the display data to the first vehicle to facilitate an augmented reality display of the second vehicle and the display data via a display screen of the first vehicle. Furthermore, based on the sending the second location data and the display data, at element 608, the method can comprise facilitating, by the access point device, a maneuver of the first vehicle to avoid the predicted location.

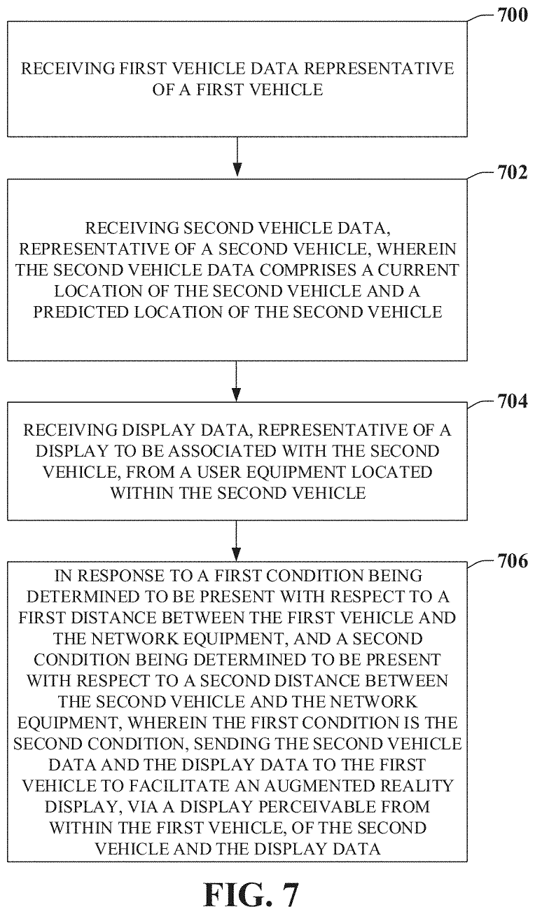

Referring now to FIG. 7, illustrated is an example flow diagram for a system for facilitating autonomous and non-autonomous vehicle interaction network according to one or more embodiments.

At element 700, the system can facilitate receiving first vehicle data representative of a first vehicle. At element 702, the system can comprise receiving second vehicle data, representative of a second vehicle, wherein the second vehicle data comprises a current location of the second vehicle and a predicted location of the second vehicle. At element 704, the system can comprise receiving display data, representative of a display to be associated with the second vehicle, from a user equipment located within the second vehicle. Furthermore, at element 706, in response to a first condition being determined to be present with respect to a first distance between the first vehicle and the network equipment, and a second condition being determined to be present with respect to a second distance between the second vehicle and the network equipment, wherein the first condition and the second condition is a same condition, the system can comprise sending the second vehicle data and the display data to the first vehicle to facilitate an augmented reality display of the second vehicle and the display data via a display screen of the first vehicle.

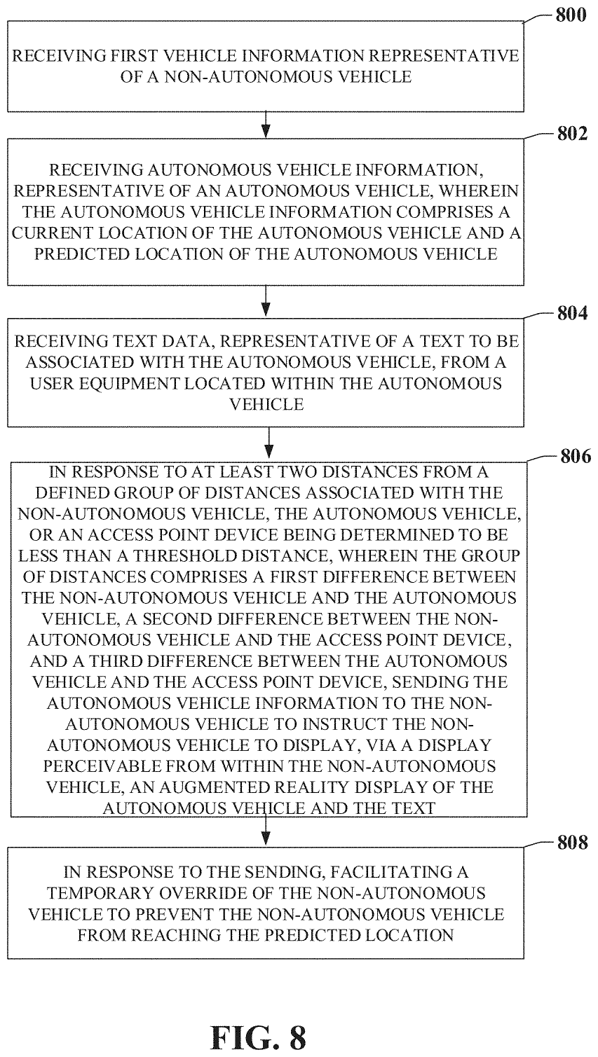

Referring now to FIG. 8, illustrated is an example flow diagram for a machine-readable medium for facilitating autonomous and non-autonomous vehicle interaction network according to one or more embodiments.

At element 800, the machine-readable medium can perform the operations comprising receiving first vehicle information representative of a non-autonomous vehicle. At element 802, the machine-readable medium can perform the operations comprising receiving autonomous vehicle information, representative of an autonomous vehicle, wherein the autonomous vehicle information comprises a current location of the autonomous vehicle and a predicted location of the autonomous vehicle. Furthermore, at element 804, the machine-readable medium can perform the operations comprising receiving text data, representative of a text to be associated with the autonomous vehicle, from a user equipment located within the autonomous vehicle. Additionally, at element 806, in response to at least two distances among the non-autonomous vehicle, the autonomous vehicle, or an access point device being determined to be less than a threshold distance, the machine-readable medium can comprise sending the autonomous vehicle information to the non-autonomous vehicle to facilitate, via a display screen of the non-autonomous vehicle, an augmented reality display of the autonomous vehicle and the text. At element 808, in response to the sending, the machine-readable medium can comprise facilitating a temporary override of the non-autonomous vehicle to prevent the non-autonomous vehicle from reaching the predicted location.

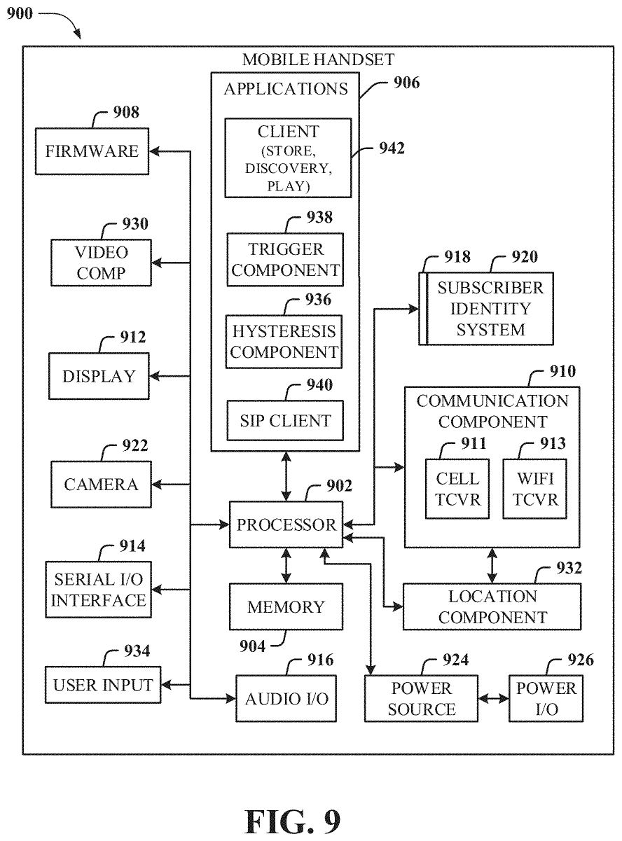

Referring now to FIG. 9, illustrated is a schematic block diagram of an exemplary end-user device such as a mobile device 900 capable of connecting to a network in accordance with some embodiments described herein. Although a mobile handset 900 is illustrated herein, it will be understood that other devices can be a mobile device, and that the mobile handset 900 is merely illustrated to provide context for the embodiments of the various embodiments described herein. The following discussion is intended to provide a brief, general description of an example of a suitable environment 900 in which the various embodiments can be implemented. While the description includes a general context of computer-executable instructions embodied on a machine-readable medium, those skilled in the art will recognize that the innovation also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of machine-readable media. Machine-readable media can be any available media that can be accessed by the computer and includes both volatile and non-volatile media, removable and non-removable media. By way of example and not limitation, computer-readable media can include computer storage media and communication media. Computer storage media can include volatile and/or non-volatile media, removable and/or non-removable media implemented in any method or technology for storage of information, such as computer-readable instructions, data structures, program modules or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The handset 900 includes a processor 902 for controlling and processing all onboard operations and functions. A memory 904 interfaces to the processor 902 for storage of data and one or more applications 906 (e.g., a video player software, user feedback component software, etc.). Other applications can include voice recognition of predetermined voice commands that facilitate initiation of the user feedback signals. The applications 906 can be stored in the memory 904 and/or in a firmware 908, and executed by the processor 902 from either or both the memory 904 or/and the firmware 908. The firmware 908 can also store startup code for execution in initializing the handset 900. A communications component 910 interfaces to the processor 902 to facilitate wired/wireless communication with external systems, e.g., cellular networks, VoIP networks, and so on. Here, the communications component 910 can also include a suitable cellular transceiver 911 (e.g., a GSM transceiver) and/or an unlicensed transceiver 913 (e.g., Wi-Fi, WiMax) for corresponding signal communications. The handset 900 can be a device such as a cellular telephone, a PDA with mobile communications capabilities, and messaging-centric devices. The communications component 910 also facilitates communications reception from terrestrial radio networks (e.g., broadcast), digital satellite radio networks, and Internet-based radio services networks.

The handset 900 includes a display 912 for displaying text, images, video, telephony functions (e.g., a Caller ID function), setup functions, and for user input. For example, the display 912 can also be referred to as a “screen” that can accommodate the presentation of multimedia content (e.g., music metadata, messages, wallpaper, graphics, etc.). The display 912 can also display videos and can facilitate the generation, editing and sharing of video quotes. A serial I/O interface 914 is provided in communication with the processor 902 to facilitate wired and/or wireless serial communications (e.g., USB, and/or IEEE 1394) through a hardwire connection, and other serial input devices (e.g., a keyboard, keypad, and mouse). This supports updating and troubleshooting the handset 900, for example. Audio capabilities are provided with an audio I/O component 916, which can include a speaker for the output of audio signals related to, for example, indication that the user pressed the proper key or key combination to initiate the user feedback signal. The audio I/O component 916 also facilitates the input of audio signals through a microphone to record data and/or telephony voice data, and for inputting voice signals for telephone conversations.

The handset 900 can include a slot interface 918 for accommodating a SIC (Subscriber Identity Component) in the form factor of a card Subscriber Identity Module (SIM) or universal SIM 920, and interfacing the SIM card 920 with the processor 902. However, it is to be appreciated that the SIM card 920 can be manufactured into the handset 900, and updated by downloading data and software.

The handset 900 can process IP data traffic through the communication component 910 to accommodate IP traffic from an IP network such as, for example, the Internet, a corporate intranet, a home network, a person area network, etc., through an ISP or broadband cable provider. Thus, VoIP traffic can be utilized by the handset 900 and IP-based multimedia content can be received in either an encoded or decoded format.

A video processing component 922 (e.g., a camera) can be provided for decoding encoded multimedia content. The video processing component 922 can aid in facilitating the generation, editing and sharing of video quotes. The handset 900 also includes a power source 924 in the form of batteries and/or an AC power subsystem, which power source 924 can interface to an external power system or charging equipment (not shown) by a power I/O component 926.

The handset 900 can also include a video component 930 for processing video content received and, for recording and transmitting video content. For example, the video component 930 can facilitate the generation, editing and sharing of video quotes. A location tracking component 932 facilitates geographically locating the handset 900. As described hereinabove, this can occur when the user initiates the feedback signal automatically or manually. A user input component 934 facilitates the user initiating the quality feedback signal. The user input component 934 can also facilitate the generation, editing and sharing of video quotes. The user input component 934 can include such conventional input device technologies such as a keypad, keyboard, mouse, stylus pen, and/or touch screen, for example.

Referring again to the applications 906, a hysteresis component 936 facilitates the analysis and processing of hysteresis data, which is utilized to determine when to associate with the access point. A software trigger component 938 can be provided that facilitates triggering of the hysteresis component 938 when the Wi-Fi transceiver 913 detects the beacon of the access point. A SIP client 940 enables the handset 900 to support SIP protocols and register the subscriber with the SIP registrar server. The applications 906 can also include a client 942 that provides at least the capability of discovery, play and store of multimedia content, for example, music.

The handset 900, as indicated above related to the communications component 910, includes an indoor network radio transceiver 913 (e.g., Wi-Fi transceiver). This function supports the indoor radio link, such as IEEE 802.11, for the dual-mode GSM handset 900. The handset 900 can accommodate at least satellite radio services through a handset that can combine wireless voice and digital radio chipsets into a single handheld device.

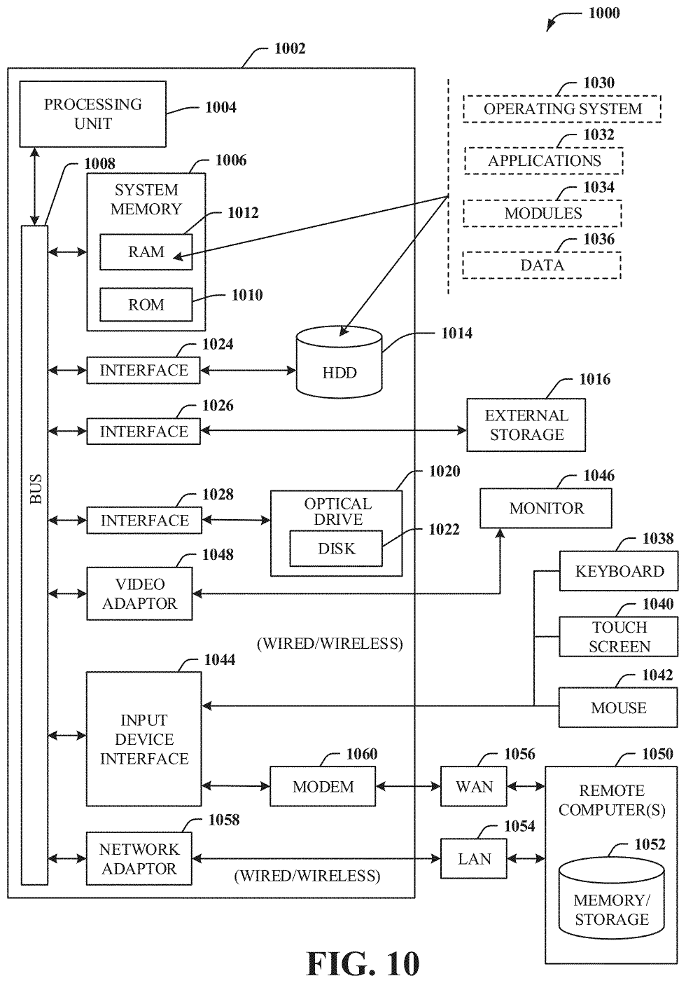

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the disclosed methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable media, machine-readable media, and/or communications media, which two terms are used herein differently from one another as follows. Computer-readable media or machine-readable media can be any available media that can be accessed by the computer and includes both volatile and nonvolatile media, removable and non-removable media. By way of example, and not limitation, computer-readable media or machine-readable media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally include emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can include one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enable with a security module, such as a trusted processing module (TPM). For instance with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The computer is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the subject matter has been described herein in connection with various embodiments and corresponding FIGs, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
receiving, by an access point device comprising a processor, first location data representative of a first location of a first vehicle;
receiving, by the access point device, second location data representative of a second location of a second vehicle and a predicted location of the second vehicle;
receiving, by the access point device from a user equipment, display data representative of a display to be associated with the second vehicle, wherein the user equipment is located within the second vehicle;
in response to receiving the second location data and based on a first distance between the access point and the first vehicle being determined to be less than a first threshold distance, and a second distance between the access point device and the second vehicle being determined to be less than a second threshold distance, sending, by the access point device, the second location data and the display data to the first vehicle to facilitate an augmented reality display of the second vehicle and the display data via a display screen of the first vehicle; and
based on sending the second location data and the display data, facilitating, by the access point device, a maneuver of the first vehicle to avoid the predicted location.

2. The method of claim 1, further comprising:
receiving, by the access point device, vehicle identification number data representative of a vehicle identification number of the second vehicle.

3. The method of claim 2, further comprising:
in response to receiving the vehicle identification number data, sending, by the access point device, the vehicle identification data to the first vehicle.

4. The method of claim 1, further comprising:
receiving, by the access point device, vehicle license plate number data representative of a vehicle license plate number of the second vehicle.

5. The method of claim 4, further comprising:
in response to receiving the vehicle license plate number data, comparing, by the access point device, the vehicle license plate number data to vehicle license plate numbers obtained via a data store.

6. The method of claim 5, further comprising:
in response to a condition associated with the comparing being determined to have been satisfied, flagging, by the access point device, the vehicle license plate number data as being associated with a vehicle of interest, resulting in flag data.

7. The method of claim 6, further comprising:
sending, by the access point device, the flag data to the first vehicle to facilitate an augmented reality display of the second vehicle and the flag data.

8. Network equipment, comprising:
a processor; and
a memory that stores executable instructions that, when executed by the processor, facilitate performance of operations, comprising:
receiving first vehicle data representative of a first vehicle;
receiving second vehicle data representative of a second vehicle, wherein the second vehicle data comprises a current location of the second vehicle and a predicted location of the second vehicle;
receiving display data, representative of a display to be associated with the second vehicle, from a user equipment located within the second vehicle; and
in response to a first condition being determined to be present with respect to a first distance between the first vehicle and the network equipment, and a second condition being determined to be present with respect to a second distance between the second vehicle and the network equipment, wherein the first condition and the second condition is a same condition, sending the second vehicle data and the display data to the first vehicle to facilitate an augmented reality display of the second vehicle and the display data via a display screen of the first vehicle.

9. The network equipment of claim 8, wherein the second vehicle data comprises vehicle type data representative of the second vehicle being an autonomous vehicle.

10. The network equipment of claim 9, wherein the second vehicle data further comprises route data representative of a route to be taken by the autonomous vehicle.

11. The network equipment of claim 10, wherein the operations further comprise:
sending the route data to the second vehicle to facilitate the autonomous vehicle traversing the route.

12. The network equipment of claim 9, wherein the operations further comprise:
based on near field communication connectivity data, associating a mobile device with the autonomous vehicle, wherein the mobile device is determined to belong to a passenger of the autonomous vehicle.

13. The network equipment of claim 12, wherein the operations further comprise:
in response to the associating, receiving communication data representative of a communication for which the passenger has specified an intent to communicate to the first vehicle.

14. The network equipment of claim 13, wherein the operations further comprise:
in response to receiving the communication data, sending the communication data to the first vehicle.

15. A non-transitory machine-readable medium, comprising executable instructions that, when executed by a processor, facilitate performance of operations, comprising:
receiving first vehicle information representative of a non-autonomous vehicle;
receiving autonomous vehicle information, representative of an autonomous vehicle, wherein the autonomous vehicle information comprises a current location of the autonomous vehicle and a predicted location of the autonomous vehicle;
receiving text data, representative of a text to be associated with the autonomous vehicle, from a user equipment located within the autonomous vehicle;
in response to at least two distances among the non-autonomous vehicle, the autonomous vehicle, or an access point device being determined to be less than a threshold distance, sending the autonomous vehicle information to the non-autonomous vehicle to facilitate, via a display screen of the non-autonomous vehicle, an augmented reality display of the autonomous vehicle and the text; and
in response to the sending, facilitating a temporary override of the non-autonomous vehicle to prevent the non-autonomous vehicle from reaching the predicted location.

16. The non-transitory machine-readable medium of claim 15, wherein the autonomous vehicle information comprises an instruction to be performed by a driver of the non-autonomous vehicle.

17. The non-transitory machine-readable medium of claim 16, wherein the operations further comprise:
in response to a time condition, associated with the instruction not being performed, being determined to have been satisfied, sending override data to the non-autonomous vehicle.

18. The non-transitory machine-readable medium of claim 17, wherein the override data comprises an instruction to the non-autonomous vehicle to temporarily initiate an autonomous function.

19. The non-transitory machine-readable medium of claim 15, wherein the operations further comprise:
based on global positioning system data, associating the user equipment with the autonomous vehicle, wherein the user equipment has been determined to belong to a passenger of the autonomous vehicle.

20. The non-transitory machine-readable medium of claim 19, wherein the operations further comprise:
in response to the associating, facilitating sending message data from the user equipment to the non-autonomous vehicle to be displayed via the augmented reality display of the non-autonomous vehicle.
